(19) United States
(12) Patent Application Publication
(10) Pub. No.: US 2008/0076414 A1
(43) Pub. Date: Mar. 27, 2008

(54) MOBILE DEVICE ADVERTISING

(76) Inventors: Akhshar Kharebov, Goleta, CA (US); Sergey Lossev, Goleta, CA (US)

Correspondence Address: HAHN AND MOODLEY, LLP, P.O. BOX 52050, MINNEAPOLIS, MN, 55402, US

(21) Appl. No.: 11/828,288

(22) Filed: Jul. 25, 2007

Related U.S. Application Data
(60) Provisional application No. 60/820,325, filed on Jul. 25, 2006.

(51) Int. Cl. H04Q 7/20

(52) U.S. Cl. 455/433

(57) ABSTRACT

In one embodiment, the invention provides an advertisement management application resident on a mobile device such as a cell phone. Advantageously, the advertisement management application is able to deliver advertisements to a user, during high periods of latency while the user is waiting for content from a network.

This application claims the benefit of priority to U.S. provisional patent application No. 60/820,325 filed Jul. 25, 2006, the specification of which is hereby incorporated by reference.

### FIELD

Embodiments of the invention relate advertising.

### BACKGROUND

Mobile devices such as cell phones, Personal Digital Assistants (PDAs), two-way pagers, etc. are extremely popular with millions of such devices in deployment worldwide. Given the widespread use of such mobile devices, these devices represent a huge target market for advertisements.

### SUMMARY

In one embodiment, the invention provides an advertisement, management application resident on a mobile device such as a cell phone. Advantageously, the advertisement management application is able to deliver advertisements to a user, during high periods of latency while the user is waiting for content from a network.

Other aspects of the present invention will become apparent from the detailed description below.

### BRIEF DESCRIPTION OF THE DRAWINGS

While the appended claims set forth the features of the present invention with particularity, the invention, together with its objects and advantages, will be more readily appreciated from the following detailed description, taken in conjunction with the accompanying drawings, wherein:

FIG. 1 shows a server comprising a notes-access application, in accordance with one embodiment of the invention.

FIG. 2 shows an exemplary hardware for implementing the server of FIG. 1

### DETAILED DESCRIPTION

In the following description, for purposes of explanation, numerous specific details are set forth in order to provide a thorough understanding of the invention. It will be apparent, however, to one skilled in the art that the invention can be practiced without these specific details. In other instances, structures and devices are shown only in block diagram form in order to avoid obscuring the invention.

Reference in this specification to “one embodiment” or “an embodiment” means that a particular feature, structure, or characteristic described in connection with the embodiment is included in at least one embodiment of the invention. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Although the following description contains many specifics for the purposes of illustration, one skilled in the art will appreciate that many variations and/or alterations to said details are within the scope of the present invention. Similarly, although many of the features of the present invention are described in terms of each other, or in conjunction with each other, one skilled in the art will appreciate that many of these features can be provided independently of other features. Accordingly, this description of the invention is set forth without any loss of generality to, and without imposing limitations upon, the invention.

Broadly, embodiments of the invention provide an advertisement management application resident on a mobile device such as a cell phone. Advantageously, the advertisement management application is able to deliver advertisements to a user, during high periods of latency while the user is waiting for content from a network.

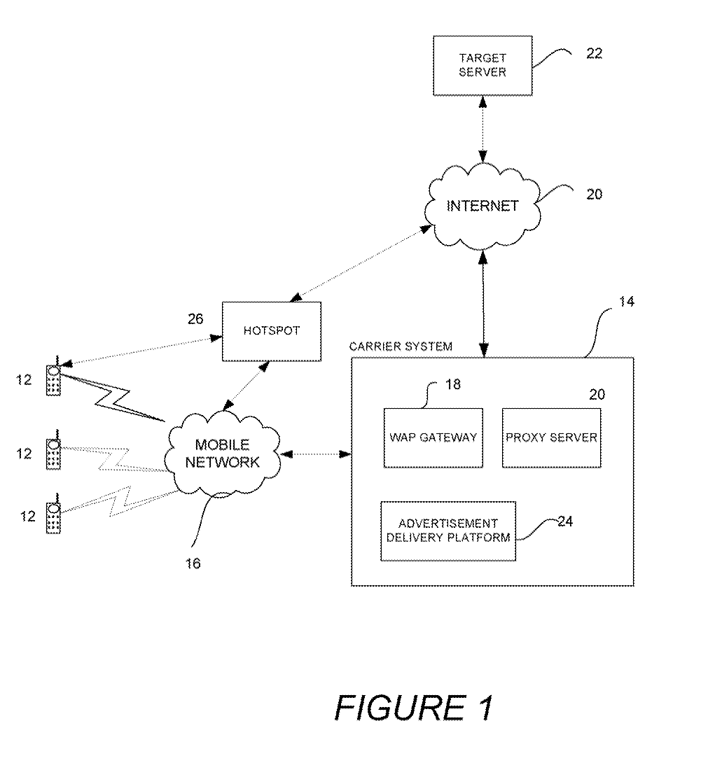

Referring now to FIG. 1 of the drawings, there is shown a network architecture 10, within which embodiments of the present invention may be practiced. As will be seen, mobile devices 12 communicate with a carrier system 14 by the mechanism of a mobile network 16. In accordance with different embodiments, the mobile network 16 may represent several mobile networks including CDMA, GPRS, EDGE, 3G, and, 4G networks, etc. In general the carrier system 14 enables the devices 12 for communications within the mobile network 16. As such, the carrier system 14 includes several components such as customer service and billing modules (not shown), etc. as will be known to one skilled in the art. The carrier system 14 also includes a WAP gateway 18, and a proxy server 20 for bridging communications between the mobile network 16 and the Internet 20. Thus, the carrier system 14 enables the devices 12 for communications with a target server 22 that represents a node within the Internet 20. In one embodiment, the carrier system 14 includes an advertisement delivery platform 24 for delivering advertisements to the mobile devices 12, in accordance with one embodiment of the invention.

Independently of the carrier system 14, the mobile devices 12 may communicate with the server 22 by the mechanism of an Internet hotspot 26 which bridges communications between the mobile devices 12 and the Internet 20, as will be known to one skilled in the art.

The mobile devices 12 represent any device capable of communicating via the mobile network 16. As such, the mobile devices 12 represent cell phones, personal digital assistants (PDAs), twp-way pagers, etc.

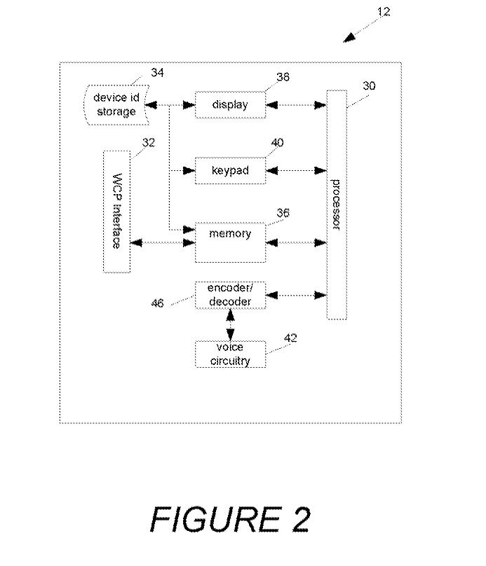

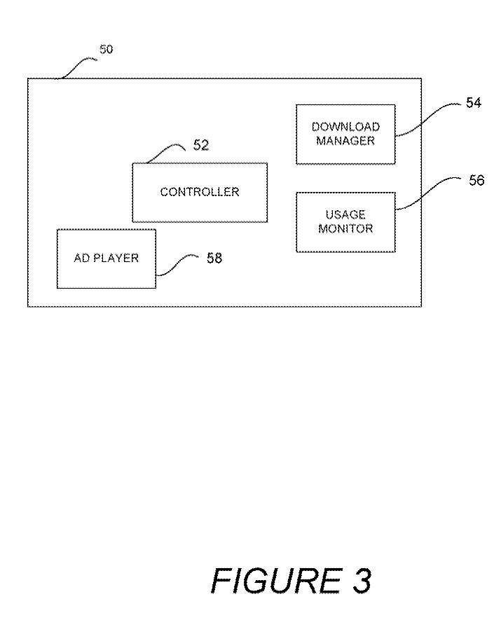

Referring now to FIG. 2 of the drawings, the principle components of a mobile device 12 in accordance with one embodiment of the invention, in the form of a mobile telephone, are shown schematically. The mobile telephone 12 includes a processor 30 which may be or may include any of: a general-or-special purpose programmable microprocessor, Digital Signal Processor (DSP), Application Specific Integrated Circuits (ASIC), Programmable Logic Array (PLA), Field Programmable Gate Array (FPGA), etc., or a combination thereof. The mobile telephone 12 includes a Wireless Control Protocol (WCP) interface 32 that couples to a carrier network via the network 16 to receive incoming and outgoing signals. A device identifier (ID) storage 34 stores and supplies to the WCP interface 32 a device ID which identifies mobile phone 12 to outside entities (e.g. the proxy server 20).

In addition, the mobile telephone 12 includes a memory 36 that stores data and/or software for performing many of the processing tasks performed by the mobile device 12 when executed by the processor 30. In one embodiment, the memory 30 includes and an advertisement application 50 (see FIG. 3) to management the playing of advertisements on the device 12 in accordance with the techniques of the present invention, as will be described in greater detail below. The memory 36 may represent one or more physical memory devices, which may include any type of Random Access Memory (RAM), Read-Only Memory (ROM), (which may be programmable). The mobile telephone 12 further includes a display 38 and a keypad 40. The mobile device 12 also includes voice circuitry 42 for inputting and outputting audio, and an encoder/decoder 44 coupled between processor 30 and voice circuitry 42 for encoding and decoding audio signals.

FIG. 3 of the drawings shows the components of the advertisement management application 40, in accordance with one embodiment of the invention. Referring to FIG. 3, it will be seen that the advertisement management application 50 comprises controller logic 52, a download manager 54, a usage monitor 56, and an advertisement player 58. In one embodiment, the controller logic 52 detects an occurrence of a high latency event such as when the mobile device 12 is accessing a network resource such as the target server 22 over the Internet 20. For example, the mobile device 12 may have initiated a request to the target server 22 for download content over the Internet 20. Typically, such an event represents a high latency event during which the user has to wait while the content downloads. During such a high latency event, a user is provided with a screen indicating that the content is still downloading. In one embodiment, if such a high latency event is detected, then the advertisement player 58 initiates a parallel process to play advertisement content to the user, while the download continues. Thus, the “downtime”, while the user is waiting for the download content is advantageously made more productive by showing the user advertisements. In some embodiments, the advertisements are selected by the advertisement delivery platform 24 for carrier system 14, based on a user's profile. In one embodiment, the user's profile is developed based on a user's interests, a history of the websites visited by the user, etc.

In one embodiment, while the advertisement player 58 plays an advertisement, the usage monitor 54 monitors usage of the device 12 to controls playback of advertisements. For example, if during playback of an advertisement, the usage monitor 54 detects that the user has activated another application, then the controller logic 52 immediately suspends playback of the advertisement. In some cases, the usage monitor 54 monitors CPU and memory usage for the device 12. If the CPU and 4/or memory usage exceeds predefined for shows, then the controller logic 52 suspends the playback of advertisements.

In one embodiment the download manager 54 detects when a device 12 is being uses to retrieve content from the Internet 20, which event serves as a trigger for the controller logic 52 to initiate playback of advertisements, as described above. In one embodiment, the download manager 44 downloads content from the advertisement delivery platform 24 ahead of time. Such pre-downloaded advertisements are stored in the memory 36 and are selected for playback by the advertisement player 58 upon the next high latency event. In some cases, the controller logic 52 may delete advertisements stored in the memory 36, in order to make more memory available to programs running on a device 12 as memory consumption by the device 12, as detected by the monitor 54, approaches a predefined threshold.

In one embodiment, the advertisement player 58 may allow a user to take an action would respect to a particular advertisement being played. For example, an advertisement may comprise a coupon redeemable at a particular store, in which case the player 58 may allow the user to save a coupon for later access. Other actions may include allowing the user to click on a link to access a website associated with the advertisement. In one embodiment, access to the website may be initiated as a parallel process to the already initiated download. Alternatively, the user may be given the option to cancel the first download the full access to the website is initiated.

In some cases, the download manager 54 plays a pre-downloaded advertisement resident in the memory 38 only if the advertisement satisfies an age test. For example, an age test may specify that advertisements downloaded more than a predefined time period ago may not be played. In one embodiment, the download manager 54 may keep the aging history for each advertisement and may be set to the download advertisements that have become aged.

In one embodiment, the application 50 may be used to play advertisements, in accordance with the above-described techniques by connecting to the system 14 via the hotspot 26.

For the purposes of this specification, a machine-readable medium includes any mechanism that provides (i.e. stores and/or transmits) information in a form readable by a machine (e.g. computer) for example, a machine-readable medium includes read-only memory (ROM); random access memory (RAM); magnetic disk storage media; optical storage media; flash memory devices; electrical, optical, acoustical or other form of propagated signals (e.g. carrier waves, infra red signals, digital signals, etc.); etc.

It will be apparent from this description the aspects of the present invention may be embodied, at least partly, in software. In other embodiments, hardware circuitry may be used in combination with software instructions to implement the present invention. Thus, the techniques are not limited to any specific combination of hardware circuitry and software.

Although the present invention has been described with reference to specific exemplary embodiments, it will be evident that the various modification and changes can be made to these embodiments without departing from the broader spirit of the invention as set forth in the claims. Accordingly, the specification and drawings are to be regarded in an illustrative sense rather than in a restrictive sense.

While certain exemplary embodiments have been described and shown in the accompanying drawings, it is to be understood that such embodiments are merely illustrative and not restrictive of the broad invention and that this invention is not limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement, and detail as facilitated by enabling technological advancements without departing from the principals of the present disclosure.

1. A method, comprising:
on a mobile device, detecting a high latency event; and
playing an advertisement during the high latency event to a user of the mobile device.

2. The method of claim 1, further comprising during said playing monitoring a status of the high latency event, and if the high latency event has ended then terminating said playing.

3. The method of claim 1, wherein the high latency event comprises waiting for downloaded content from a network.

4. The method of claim 1, wherein said playing comprises displaying the advertisement.

5. The method of claim 4, further comprising allowing the user to perform at least one action with respect to the advertisement.

6. The method of claim 5, wherein the action comprises saving the advertisement.

7. The method of claim 5, wherein the action comprises connecting to a network location provided in the advertisement.

8. The method of claim 1, further comprising downloading the advertisement before time, in anticipation of the high latency event.

9. The method of claim 8, further comprising storing the advertisement in a memory.

10. The method of claim 8, further comprising managing said memory by deleting the advertisement therefrom based on the memory requirements of programs running on the mobile device.

11. The method of claim 1, wherein the advertisement comprises a coupon.

12. A machine-readable medium having stored thereon, a sequence of instructions which when executed by a processor, cause the processor to perform and method comprising:
on a mobile device, detecting a high latency event; and
playing an advertisement during the high latency event to a user of the mobile device.

13. The machine-readable medium of claim 12, wherein the method further comprises during said playing monitoring a status of the high latency event, and if the high latency event has ended then terminating said playing.

14. A mobile device, comprising;
a processor; and
the memory coupled to the processor, the memory storing instructions which when executed by the processor cause the mobile device to perform a method comprising:
detecting a high latency event; and
playing an advertisement during the high latency event to a user of the mobile device.

15. The mobile device 14, wherein the method further comprises during said playing monitoring a status of the high latency event, and if the high latency event has ended then terminating said playing.

16. The mobile device 14, wherein the high latency event comprises waiting for downloaded content from a network.

17. The mobile device of claim 14, wherein said playing comprises displaying the advertisement.

18. The mobile device of claim 17, wherein the method further comprises allowing the user to perform at least one action with respect to the advertisement.

19. The mobile device of claim 18, wherein the action comprises saving the advertisement.

20. The mobile device of claim 18, wherein the action comprises connecting to a network location provided in the advertisement.
